(19) United States
(12) Patent Application Publication
(10) Pub. No.: US 2021/0221647 A1
(43) Pub. Date: Jul. 22, 2021

(54) CLIMBING ELEVATOR WITH LOAD-BASED TRACTION FORCE

(71) Applicant: OTIS ELEVATOR COMPANY, Farmington, CT (US)

(72) Inventors: Sam Thieu WONG, Bridgeport, CT (US); Kiron BHASKAR, Farmington, CT (US); Bruce P. SWAYBILL, Farmington, CT (US); Randy ROBERTS, Hebron, CT (US); Meghan MASTRIANO, East Haven, CT (US)

(21) Appl. No.: 16/945,831

(22) Filed: Aug. 1, 2020

Related U.S. Application Data
(63) Continuation-in-part of application No. 16/747,845, filed on Jan. 21, 2020.

(51) Int. Cl. B66B 9/02; B66B 1/44; B66B 1/32

(52) U.S. Cl. CPC B66B 9/02; B66B 1/32; B66B 1/44

(57) ABSTRACT

An illustrative example embodiment of an elevator includes an elevator car and a drive mechanism connected with the elevator car. The drive mechanism moves with the elevator car in a vertical direction. The drive mechanism includes at least one drive member that is configured to engage a vertical structure near the elevator car, selectively climb along the vertical structure to cause movement of the elevator car, and selectively prevent movement of the elevator car when the drive member remains in a selected position relative to the vertical structure. A biasing mechanism urges the drive member in a direction to engage the vertical structure. The biasing mechanism applies a biasing force based upon a condition of the elevator car. The biasing force changes based upon a change in the condition.

### CROSS-REFERENCE TO RELATED APPLICATIONS

This application is a continuation-in-part of U.S. patent application Ser. No. 16/747,845, which was filed on Jan. 21, 2020.

### BACKGROUND

Elevator systems have proven useful for carrying passengers among various levels within a building. There are various types of elevator systems. For example, some elevator systems are considered hydraulic and include a piston or cylinder that expands or contracts to cause movement of the elevator car. Other elevator systems rely on suspending ropes or belts between the elevator car and a counterweight. A machine includes a traction sheave that causes movement of the ropes or belts to achieve the desired movement and positioning of the elevator car. Hydraulic systems are generally considered useful in buildings that have a few stories while roped systems are typically used in taller buildings.

Each of the known types of elevator systems has features that present challenges for some implementations. For example, although roped elevator systems are useful in taller buildings, in ultra-high rise installations the ropes or belts are so long that they introduces appreciable mass and expense. The added mass of long ropes requires more power and that results in added power consumption cost. Sag due to stretch and bounce of the elevator car are other issues associated with longer ropes or belts. Additionally, longer ropes or belts and taller buildings are more susceptible to sway and drift, each of which requires additional equipment or modification to the elevator system.

### SUMMARY

An illustrative example embodiment of an elevator includes an elevator car and a drive mechanism connected with the elevator car. The drive mechanism moves with the elevator car in a vertical direction. The drive mechanism includes at least one drive member that is configured to engage a vertical structure near the elevator car, climb along the vertical structure to selectively cause movement of the elevator car, and selectively prevent movement of the elevator car when the drive member remains in a selected position relative to the vertical structure. A biasing mechanism urges the drive member in a direction to engage the vertical structure. The biasing mechanism applies a biasing force based upon a condition of the elevator car. The biasing force changes based upon a change in the condition.

In an example embodiment having at least one feature of the elevator of the previous paragraph, the vertical structure includes a traction surface that the at least one drive member engages, the at least one drive member rotates while engaging the traction surface, and the biasing force is normal to the traction surface.

In an example embodiment having at least one feature of the elevator of either of the previous paragraphs, the biasing mechanism comprises an actuator that applies the biasing force, and the actuator varies the biasing force based on the change in the condition.

In an example embodiment having at least one feature of the elevator of any of the previous paragraphs, the condition comprises a load of the elevator car, and comprising a sensor that provides an output indicating the load of the elevator car. A controller determines the load in the elevator car based on the output of the sensor. The actuator is controlled by the controller to change the biasing force for urging the at least one rotatable drive member to engage the vertical structure based on the change in the load in the elevator car.

In an example embodiment having at least one feature of the elevator of any of the previous paragraphs, the actuator increases the biasing force for urging the at least one rotatable drive member in a direction to engage the vertical surface based on an increase in the load of the elevator car and decreases the biasing force for urging the at least one rotatable drive member in the direction to engage the vertical surface based on a decrease in the load in the elevator car.

An example embodiment having at least one feature of the elevator of any of the previous paragraphs includes a feedback sensor that provides an indication of the biasing force between the at least one rotatable drive member and the vertical structure. The controller uses the indication from the feedback sensor to selectively adjust the biasing force applied by the actuator.

In an example embodiment having at least one feature of the elevator of any of the previous paragraphs, the at least one drive member comprises a plurality of rotatable drive members, the biasing mechanism comprises a plurality of beams supported for movement in a first direction to urge the at least one rotatable drive member into engagement with the vertical structure, the at beams move at least partially in a first direction based upon a force in a second, different direction, and the load of the elevator car is in the second direction.

In an example embodiment having at least one feature of the elevator of any of the previous paragraphs, the plurality of beams that are supported for pivotal movement relative to each other to change the biasing force.

In an example embodiment having at least one feature of the elevator of any of the previous paragraphs, the biasing mechanism includes an actuator that causes movement of the beams based on a change in the load of the elevator car and the actuator is one of electrical, electromagnetic, hydraulic or pneumatic.

In an example embodiment having at least one feature of the elevator of any of the previous paragraphs, the at least one drive member comprises a plurality of rotatable drive members, the drive members are supported by flexible mounts, and the biasing mechanism includes at least one actuator that changes a condition of the flexible mounts to change the biasing force.

In an example embodiment having at least one feature of the elevator of any of the previous paragraphs, the actuator imposes a force on the flexible mounts to change the condition.

In an example embodiment having at least one feature of the elevator of any of the previous paragraphs, the actuator causes deflection of the flexible mounts to change the biasing force.

In an example embodiment having at least one feature of the elevator of any of the previous paragraphs, the biasing mechanism includes deflectors that are moveable by the actuator to deflect the flexible mounts in a manner that changes the biasing force.

In an example embodiment having at least one feature of the elevator of any of the previous paragraphs, the biasing mechanism includes a chamber configured to contain a fluid, the biasing force is based on an amount of fluid in the chamber or a pressure of the fluid in the chamber, the biasing mechanism includes a plunger that is moveable relative to the chamber based on a change in the load of the elevator car, and movement of the plunger changes the biasing force.

In an example embodiment having at least one feature of the elevator of any of the previous paragraphs, the biasing mechanism includes a vacuum chamber that establishes an at least partial vacuum to apply the biasing force.

In an example embodiment having at least one feature of the elevator of any of the previous paragraphs, the vacuum chamber includes a flexible seal that is received against a surface of the vertical structure, the flexible seal is moveable in a vertical direction along the surface as the elevator car moves, and vacuum pressure of the vacuum chamber urges the at least one rotatable drive member into engagement with the vertical structure.

An illustrative example embodiment of a method of controlling movement of an elevator car includes connecting a drive mechanism with the elevator car. The drive mechanism includes at least one drive member that is configured to engage a vertical structure near the elevator car. The drive mechanism moves with the elevator car in a vertical direction as the drive member climbs along the vertical structure. Movement of the elevator car is prevented by maintaining the drive member in a selected position relative to the vertical structure. The drive member is selectively urged in a direction to engage the vertical structure by a biasing mechanism that applies a biasing force based upon a condition of the elevator car and changes the biasing force based upon a change in the condition.

In an example embodiment having at least one feature of the method of the previous paragraph, the condition comprises at least one of a load of the elevator car and an status of the elevator car.

In an example embodiment having at least one feature of the method of either of the previous paragraphs, the status includes an active status in which the elevator car is providing elevator service or an inactive status in which the elevator car is parked in a designated position.

An example embodiment having at least one feature of the method of any of the previous paragraphs includes releasing the biasing force when the inactive status includes the elevator car parked in the designated position and vertically supported independent of the at least one drive member engaging the vertical structure.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example embodiment of an elevator system.

FIG. 2 schematically illustrates selected features of the embodiment of FIG. 1 viewed from underneath the elevator car.

FIG. 3 schematically illustrates selected portions of another example elevator system embodiment.

FIG. 4 schematically illustrates selected features of the elevator car of FIG. 3.

FIG. 5 schematically illustrates selected features of an example rotatable drive member useful with the embodiments shown in FIGS. 1-4.

FIG. 6 schematically illustrates a biasing mechanism useful, for example, with the embodiment shown in FIGS. 1 and 2.

FIG. 7 illustrates an example configuration of a passive biasing mechanism that may be used in the arrangement shown in FIG. 6.

FIG. 8 schematically illustrates a biasing mechanism useful, for example with the embodiment shown in FIGS. 3 and 4 and that may include the features shown in FIG. 7.

FIG. 9 schematically illustrates an active biasing mechanism.

FIG. 10 schematically illustrates an active biasing mechanism that moves parallel beams relative to each other to vary a biasing force.

FIG. 11 schematically illustrates an active biasing mechanism that moves beams in a scissors configuration relative to each other to vary a biasing force.

FIG. 12 schematically illustrates another active biasing mechanism that includes beams in a scissors configuration.

FIG. 13 schematically illustrates an active biasing mechanism that includes flexible or spring-based mounts for supporting drive members.

FIG. 14 schematically illustrates another active biasing mechanism that includes flexible or spring-based mounts for supporting drive members.

FIG. 15 schematically illustrates another active biasing mechanism configuration.

FIG. 16 schematically illustrates an elevator car with a passive, hydraulic biasing mechanism and an active biasing mechanism.

FIG. 17 schematically illustrates an active biasing mechanism that utilizes air to vary a biasing force.

FIG. 18 diagrammatically illustrates an electromechanical actuator useful in disclosed embodiments that include an active biasing mechanism.

### DETAILED DESCRIPTION

Disclosed example embodiments include controlling a force associated with establishing traction for a drive member that climbs a vertical structure to move an elevator car. The force control is based on a condition of the elevator car, such as the load of the elevator car or if it is currently providing service. The force control system may apply different forces and be active under only selected conditions. The disclosed embodiments prolong the useful life of the drive mechanism components. In some embodiments, a sensor that detects the force can be used as a safety device.

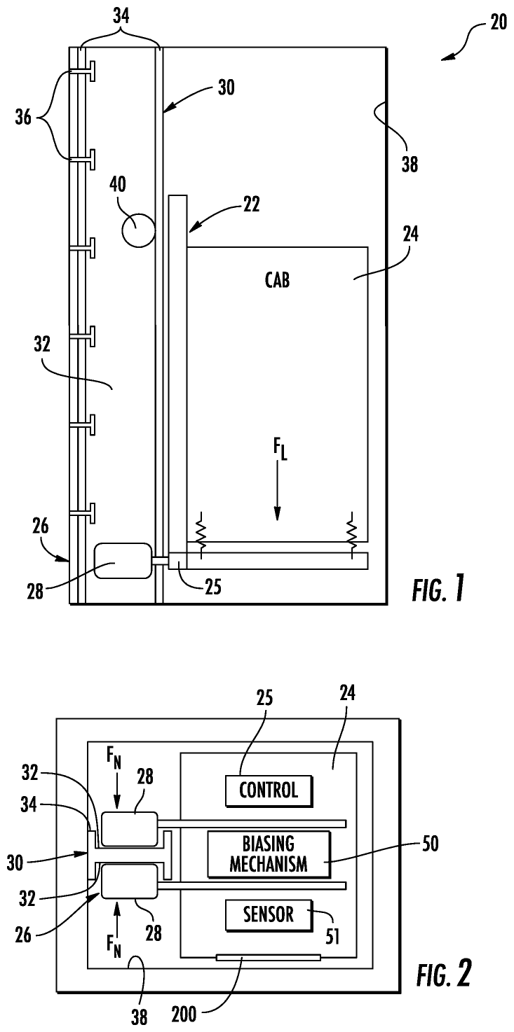

FIG. 1 schematically illustrates selected portions of an elevator system 20. An elevator car 22 includes a frame that supports a cab 24 and a drive mechanism 26. An elevator controller 25, which includes a computing device such as a microprocessor, controls various aspects of the operation of the drive mechanism 26. For example, the controller 25 controls the drive mechanism 26 to move or park the elevator car 22 as needed to provide elevator service to passengers.

The drive mechanism 26 includes at least one rotatable drive member 28 that is configured to engage a vertical structure. The rotatable drive member 28 selectively causes vertical movement of the elevator car 22 as the rotatable drive member 28 rotates and moves along the vertical structure. The rotatable drive member 28 maintains a desired vertical position of the elevator car 22 when the rotatable drive member 28 engages the vertical structure remains stationary and does not rotate.

As can be seen in FIG. 2, for example, the illustrated example embodiment includes two rotatable drive members 28. In the illustrated example embodiment, the drive mechanism 26 and the rotatable drive members 28 are situated near the bottom of the elevator car 22. This arrangement takes advantage of the structural rigidity at the lower portion of the elevator car frame.

The vertical structure in the example embodiment of FIGS. 1 and 2 includes a structural member 30 in the form of an I-beam that includes a web 32 and flanges 34. The web 32 defines a vertical surface that the rotatable drive members 28 engage. In the illustrated example embodiment, the rotatable drive members 28 engage opposite sides of the web 32. The rotatable drive members 28 engage the web 32 with sufficient force to achieve traction for controlling vertical movement and position of the elevator car 22.

In the illustrated example embodiment, the structural member 30 is secured by mounting brackets 36 to one side of a hoistway 38. Other embodiments include a structural member that is made as part of the hoistway 38 or a corresponding portion of the building in which the elevator system 20 is installed. There are a variety of ways of providing a vertical structure including a traction surface 32 that can be engaged by one or more rotatable drive members 28 for purposes of propelling and supporting the elevator car.

In the example of FIGS. 1 and 2, the drive members 28 are situated on only one side of the elevator car 22. This results in a cantilevered arrangement of the elevator car 22. A stabilizer 40 is provided near the one side of the elevator car 22 to prevent the elevator car 22 from tipping away from the structural member 30. In this example, the stabilizer 40 includes at least one roller that engages a surface on at least one of the flanges 34 of the I-beam structural member 30. In some embodiments, the stabilizer 40 includes rollers configured like guide rollers on known elevator systems.

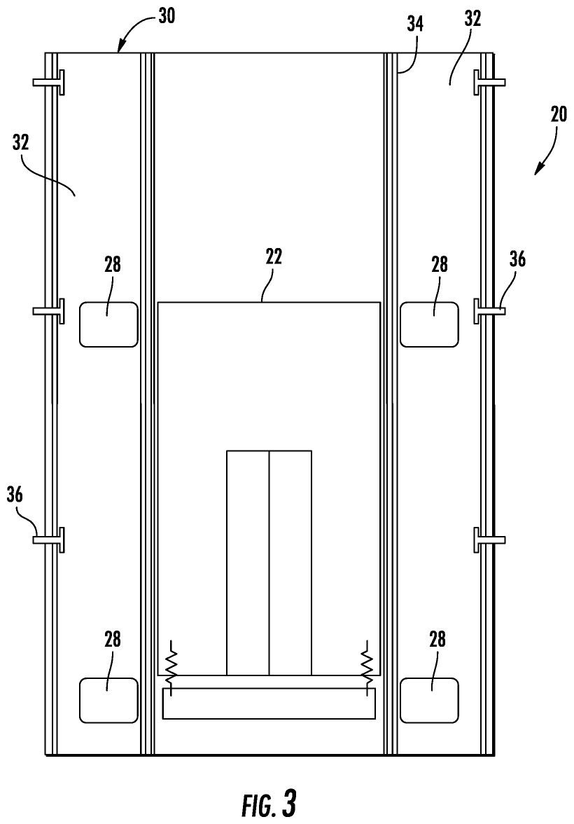

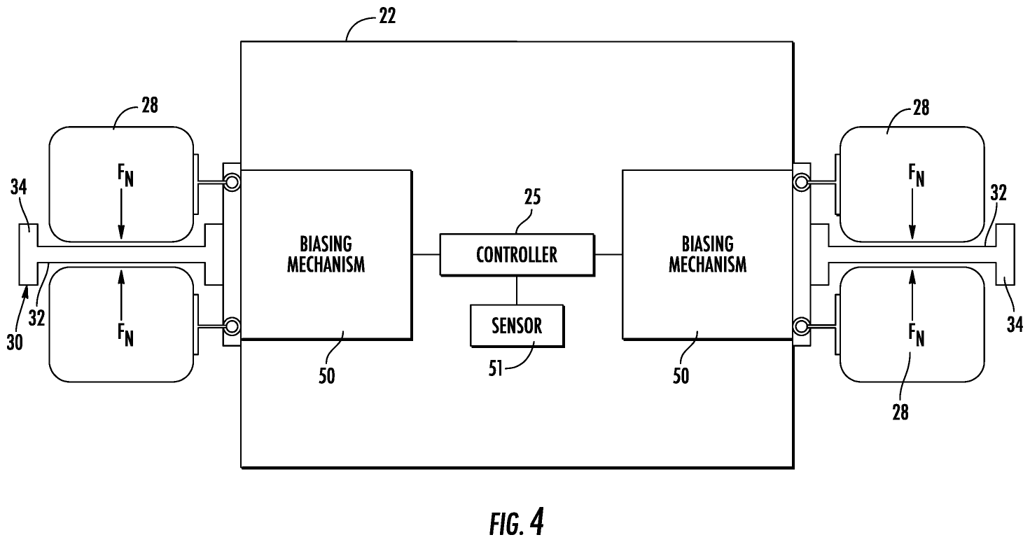

FIGS. 3 and 4 illustrate another configuration of an elevator system 20 in which the elevator car 22 is not cantilevered. In this example, the drive mechanism 26 includes rotatable drive members 28 on both sides of the elevator car 22. The example of FIG. 3 includes drive members 28 near the top and bottom of the elevator car 22. Other embodiments include drive members 28 only near the top or only near the bottom of the elevator car 22.

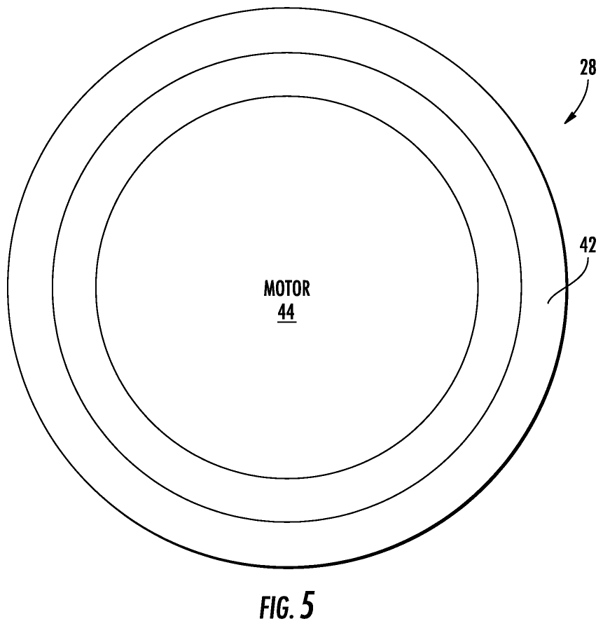

FIG. 5 illustrates an example rotatable drive member 28. A wheel or tire 42 provides the engagement surface for engaging the vertical surface 32 to achieve sufficient traction for controlling movement of the elevator car 22. A motor 44 in this example embodiment is situated within the rotatable drive member 28, which provides a compact arrangement of components that is capable of achieving the necessary torque to cause desired movement and stable positioning of the elevator car 22 based on engagement with the vertical surface 32.

As shown schematically in FIGS. 2 and 4, a biasing mechanism 50 is associated with the drive mechanism 26. The biasing mechanism 50 applies a biasing force F_{N} that is normal or perpendicular to the vertical surface 32 engaged by each drive member 28 in the illustrated embodiments to urge the rotatable drive members 28 into engagement with the example vertical surfaces 32.

The biasing mechanism 50 applies the biasing force depending on a condition of the elevator car 22. For example, the biasing force depends on or is in response to a load of the elevator car 22. The biasing force changes based on changes in the load of the elevator car 22. In some embodiments, the biasing mechanism 50 has a default condition that applies a maximum biasing force available from the biasing mechanism 50. The biasing mechanism 50 reduces the biasing force in such embodiments by an amount that is based on the load of the elevator car 22. The default condition in such embodiments ensures sufficient traction to hold the elevator car 22 in a stable position during a power failure, for example.

The biasing mechanism 50 in other embodiments has a default condition that applies a relatively low biasing force when the elevator car 22 is empty. The biasing mechanism in such embodiments increases the biasing force from that of the default condition based on changes in the load of the elevator car 22.

In some embodiments, when the elevator car 22 is parked and supported vertically, such as by a buffer beneath the elevator car 22, the biasing mechanism 50 releases any normal force. This allows for reducing any unnecessary load on the drive members 28 and associated components. When the drive members 28 include rubber tires, for example, releasing the biasing force entirely avoids developing flat spots on the tires.

The example configurations shown in FIGS. 2 and 4 include a sensor 51 that is configured to detect the load of the elevator car 22. The sensor 51 provides an indication of the load to the controller 25 and the controller 25 may use that indication to control the biasing mechanism 50 to change the biasing force depending on the current load. Some arrangements include an active biasing mechanism that is controlled by the controller 25 while others are passive and respond to a change in the load of the elevator car 22 without requiring action by the controller 25.

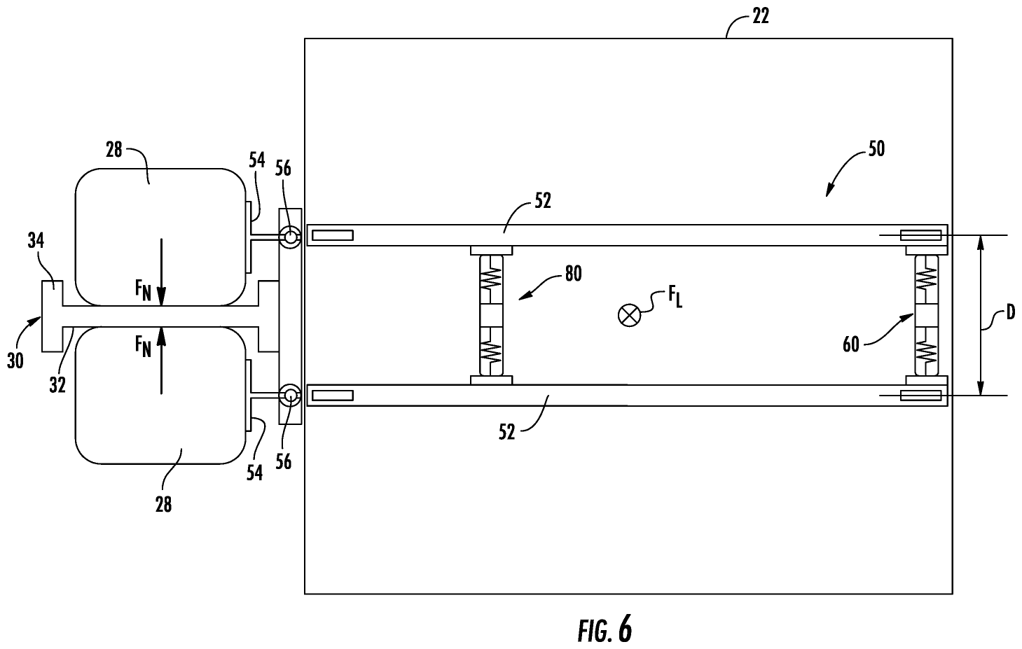

One example type of passive biasing mechanism 50 that is useful with a cantilevered elevator car 22 is schematically shown in FIG. 6. This example biasing mechanism 50 includes beams 52 that are associated with drive member supports 54. In this example, the drive member supports 54 and the beams 52 are situated for pivotal movement relative to the elevator car 22 about pivots 56. In this example, first ends of the beams 52 are situated near the drive member supports 54 while second ends of the beams 52 are distal from the rotatable drive members 28.

At least one actuator 60 selectively changes a distance D between the second ends of the beams 52 to change the engagement force F_{N} with which the rotatable drive members 28 engage the vertical surfaces of the web 32 of the I-beam structural member 30. The actuator 60 changes the distance D in response to a change in the load in the elevator cab 24. The load in the cab 24 imposes a downward force F_{L}. The actuator 60 urges the distal ends of the beams 52 away from each other to urge the rotatable drive members 28 in a direction to engage the vertical surfaces on the web 32 of the I-beam structural member 30. In the illustrated example embodiment, the movement of the beams 52 is in a first direction, which is horizontal, and the force F_{L} associated with the load in the elevator cab 24 is in a second direction, which is vertical. In the illustrated example embodiment, the first direction is perpendicular to the second direction.

The actuator 60 facilitates changing the amount of engagement force or normal force F_{N} to accommodate differences in load in the elevator car 24. Such an arrangement facilitates maintaining adequate traction between the drive mechanism 26 and the structural member 30 without maintaining forces or conditions that would tend to introduce additional wear on the components of the drive mechanism 26 or the structural member 30, for example.

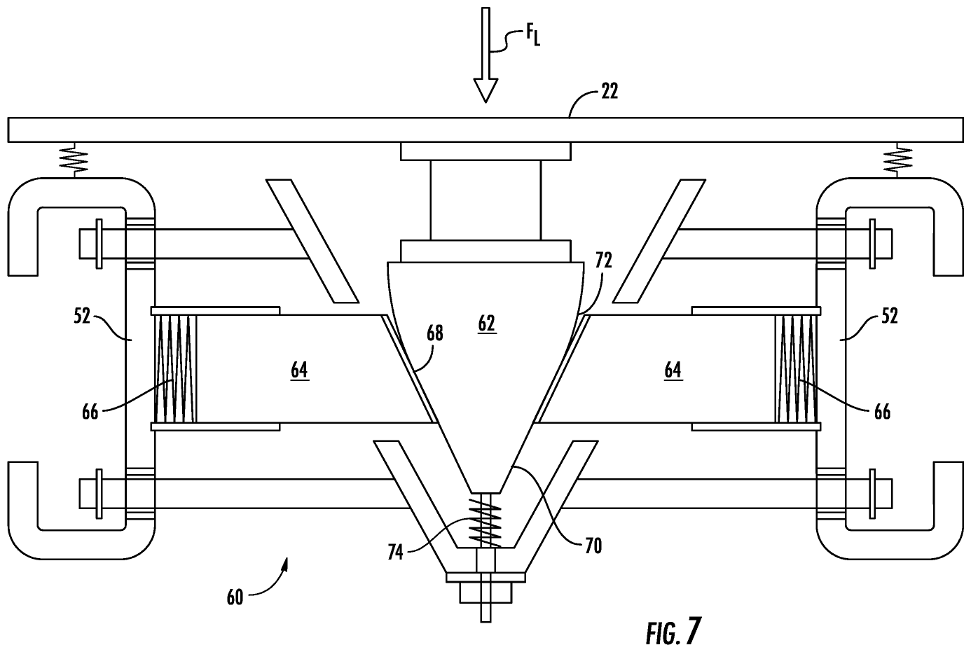

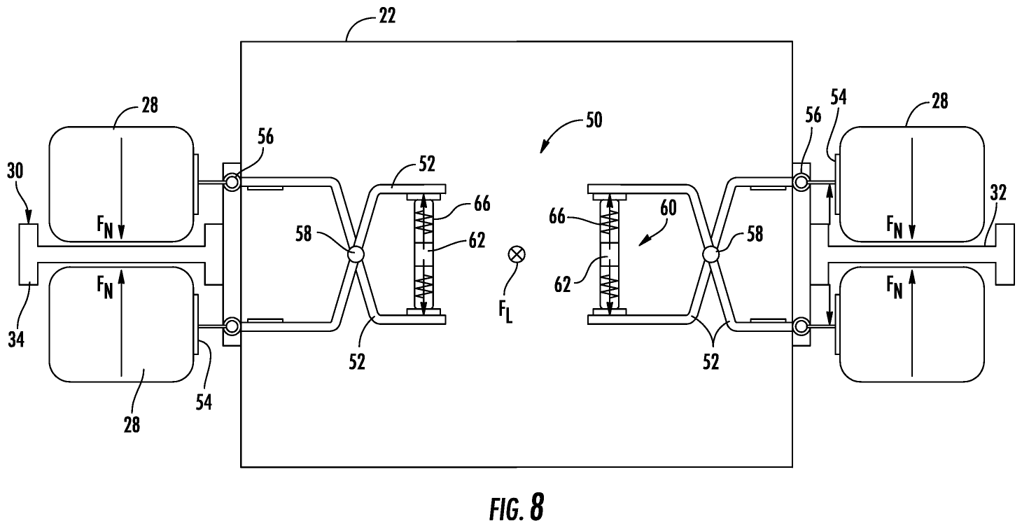

FIG. 7 illustrates an example arrangement of an actuator 60 useful in the arrangement shown in FIG. 6. In this example, a wedge-shaped actuator portion 62 moves in response to the force F_{L} caused by the load in the elevator cab 24. Downward movement (according to the drawing) of the wedge-shaped actuator portion 62 causes sideways and outward movement (according to the drawing) of intermediate members 64 against the bias of springs 66. As the intermediate members 64 move outward, they urge the nearby second ends of the beams 52 to spread apart, increasing the distance D shown in FIG. 6.

In this example embodiment, the wedge-shaped actuator portion 62 engages a ramped surface 68 on the intermediate members 64. The outer surface of the actuator portion 62 and the ramped surfaces 68 are coated with a low friction material in some embodiments. The wedge-shaped actuator portion 62 includes an angled surface that has a first profile 70 along a portion of the angled surface and a second profile 72 along another portion of the angled surface. The first profile 70 includes a steeper angle than an angle of the second profile 72. Additionally, the second profile 72 includes a curvature. The second profile 72 reduces the frictional load associated with engaging the angled surfaces 68 as the force F_{L} increases. The second profile 72 compensates for an increase in the co-efficient of friction by reducing the effect of the normal force at the interface of the second profile 72 and the angled surfaces 68 under higher loads in the elevator cab 24.

As can be appreciated from FIGS. 6 and 7, as the force F_{L} increases, the actuator 60 increases the distance D, which results in the rotatable drive members 28 moving toward the vertical surfaces on the web 32 of the I-beam structural member 30. In other words, the actuator 60 increases the engagement force F_{N} between the rotatable drive members 28 and the vertical surfaces 32 based upon an increase in the load in the elevator cab 24. An increased engagement force provides the appropriate amount of traction for achieving desired movement of the elevator car 22 and for parking the cab 24 at a desired landing.

As shown in FIG. 6, a counterbalancing mechanism 80 provides a bias for urging the beams 52 back toward a default position corresponding to a minimum amount of normal force F_{N} applied by the rotatable drive members 28 to the vertical surfaces 32. The minimum normal force F_{N} is useful for conditions such as an empty elevator cab 24. As the load in the elevator cab 24 decreases, a spring 74 (FIG. 7) urges the wedge-shaped actuator portion 62 in an upward direction (according to the drawing). Under those conditions, the counterbalancing mechanism 80 urges the first ends of the beams 52 apart and decreases the distance D between the second ends of the beams 52.

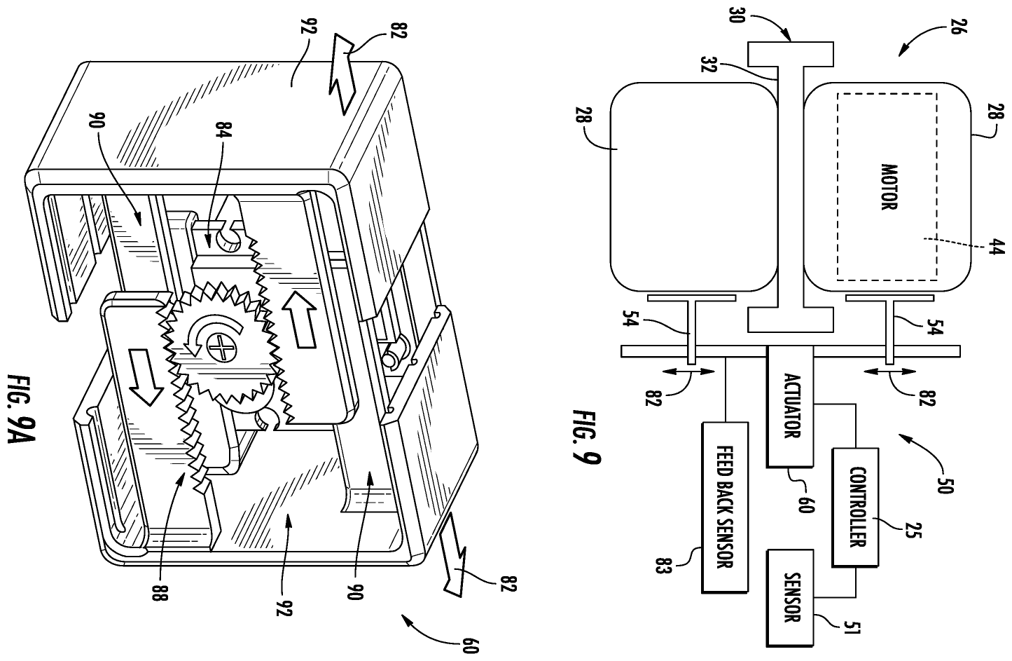

FIG. 8 schematically illustrates a biasing mechanism 50 that is configured for use on an elevator car 22 that is not cantilevered. In this example, the actuator 60 can be passive and operate similar to that shown in FIG. 7. The beams 52 in this example include multiple segments and a second pivot 58 so that the ends of the beams 52 situated closer to the center of the elevator car 22 are moveable relative to each other. Changing the distance between those ends of the beams 52 changes the normal or engagement force of the drive members 28 against the vertical surfaces 32.

While not illustrated in FIG. 8, such embodiments may include a counterbalancing mechanism 80 between the pivot locations 58 and the vertical structures 30 to return the biasing force to a force corresponding to an empty cab 24 whenever there is no additional load on the elevator car 22. As the load of the elevator car 22 increases, the actuators 60 urge the inner ends of the beams 52 further apart and, therefore, increase the biasing force urging the drive members 28 against the surfaces 32. If counterbalancing mechanisms 80 are included, they impose an opposite force urging the outer ends of the beams 52 apart into a position that maintains a minimum acceptable engagement force urging the drive members 28 into engagement with the surfaces 32. The counterbalancing mechanism 80 will not overcome a base clamping or biasing force that urges the drive members 28 into engagement with the surfaces 32 sufficient to support the load of an empty cab for preventing undesired or unexpected descent of the elevator car 22.

Some embodiments include active control over the biasing mechanism 50 and the biasing force based on the load of the elevator car 22.

FIG. 9 schematically illustrates an example embodiment in which the sensor 51 provides an output indicating the load of the elevator car 22 to the controller 25. The actuator 60 in FIG. 9, such as an electric linear actuator, is active in response to commands from the controller 25 and changes a position of the rotatable drive members 28 relative to the structural members 30 as schematically shown by the arrows 82 to alter the engagement force based on changes in the load as indicated by the sensor 51. The controller 25 controls the actuator 60 to achieve a desired engagement force corresponding to the current load in the elevator car 24.

A feedback sensor 83 provides an indication of the force applied by the biasing mechanism 50. The controller 25 in this example uses the indication from the feedback sensor 83 to adjust the biasing force if needed. One way in which the feedback sensor 83 is useful is to provide an indication of the biasing force at each drive member 28 so that the controller 25 can adjust the biasing force at each drive member 28 individually to ensure a desired distribution of the traction forces among the drive members 28.

Only one set of drive members 28 and a single actuator is shown in FIG. 9 for discussion purposes but all drive members 28 that use traction and engagement with a corresponding surface 32 has an associated actuator 60 that applies the biasing force based on the load of the elevator car 22.

FIG. 9A shows an example configuration of an electromechanical actuator 60 that is included in some embodiments. The actuator 60 in this example includes an actuator motor 84 that causes rotation of a spur gear 86. Rack gears 88 move linearly in a direction dictated by the direction of rotation of the spur gear 86. The rack gears 88 and guide beams 90 are connected with connecting structural members 92 that are configured to be connected with the drive member supports 54 to alter the biasing force urging the drive members 28 into engagement with the surfaces 32. As the spur gear 86 rotates, the rack gears 88 move in opposite directions so the drive member supports 54 move as represented by the arrows 82.

Other embodiments include an electromechanical actuator 60 that has a ball screw configuration or a self-locking worm gear. Some such actuators 60 have a feature that avoids back-driving so the actuator is capable of maintaining the positions of the components to apply a selected biasing force without requiring a constant supply of electrical energy.

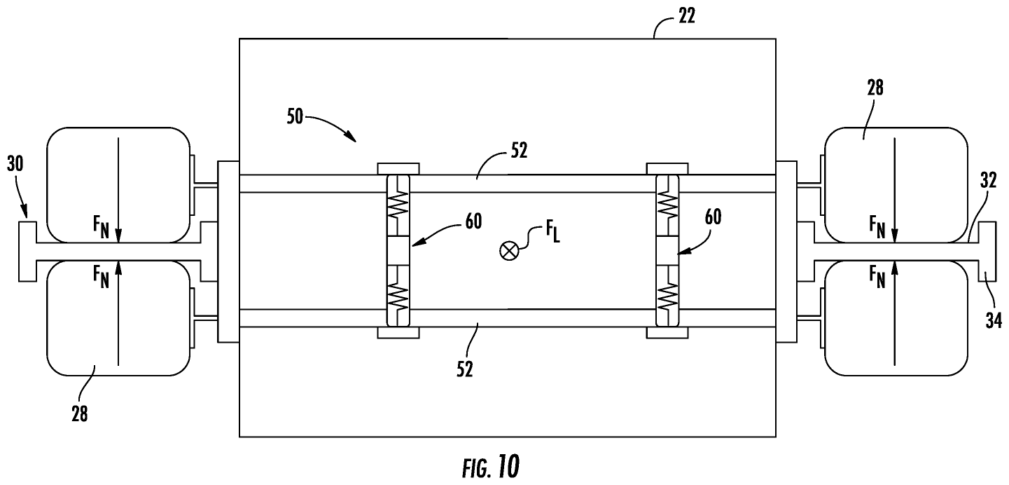

FIG. 10 schematically shows a biasing mechanism 50 that includes active actuators 60 for altering the biasing force urging the drive members 28 toward the surfaces 32. In this example embodiment, the beams 52 are moved toward each other by the actuators 60 to increase the biasing force or away from each other to decrease the biasing force. The controller 25 (not shown in FIG. 10) controls the actuators 60 depending on the load of the elevator car. The actuators 60 in FIG. 10 operate on electric power in some embodiments, hydraulic pressure in some embodiments, pneumatic pressure in some embodiments, electromagnetic attraction in some embodiments or based on an electric field in some embodiments.

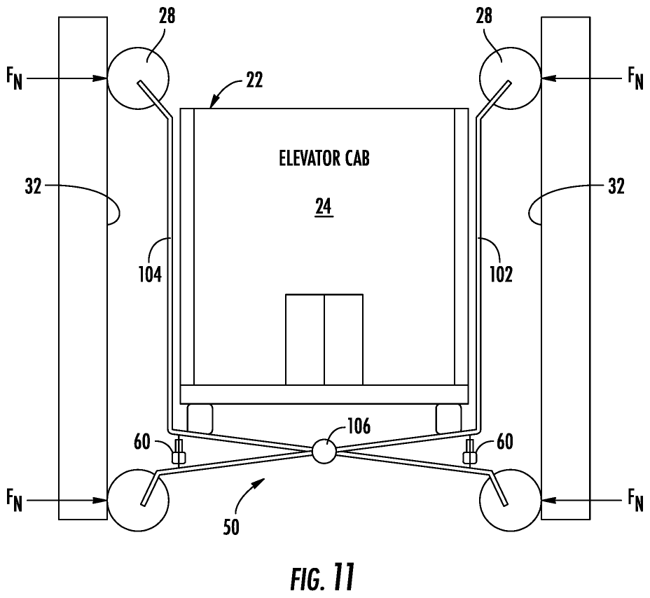

FIG. 11 shows another configuration of a biasing mechanism 50 that changes the biasing force based on changes in the load of the elevator car 22. In this example, beams 102 and 104 support the drive members 28. The beams 102 and 104 are in a scissors configuration and can move relative to each other and the elevator car 22 by pivoting about a pivot 106. Actuators 60 cause relative movement of the beams 102 and 104 to change the biasing force urging the drive members 28 toward the surfaces 32. The actuators 60 in some such embodiments utilize or operate on electric power and include solenoids, rack and pinion gears, ball screws, or electric linear actuators. Other embodiments include actuators 60 that are hydraulic and operate based on pressurized fluid or pneumatic and operate based on pressurized gas. As the actuators 60 expand in the illustrated arrangement, the beams 102 and 104 move in a direction that reduces the biasing force. The actuators 60 contract to increase the biasing force.

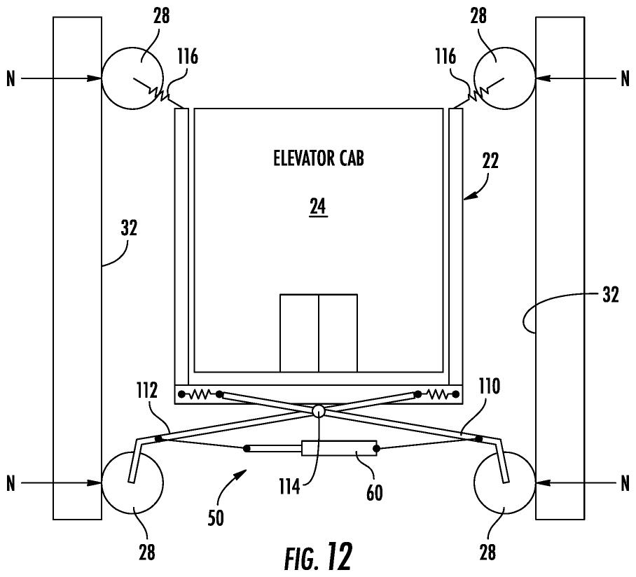

FIG. 12 shows another biasing mechanism configuration. In this example embodiment, beams 110 and 112 move relative to each other about a pivot 114 based on operation of the actuator 60. The scissors-type configuration of the beams 110 and 112 provides the ability to adjust the biasing force imposed on the drive members 28 by expanding or contracting the actuator 60. In such embodiments, the actuator may be electric, electromagnetic, electromechanical, hydraulic or pneumatic.

In FIG. 12, the drive members 28 near the top of the elevator car 22 are not affected by the actuator 60 or the biasing mechanism 50. Those drive members 28 near the top of the elevator car 22 are spring biased into engagement with the surfaces 32 using a biasing force that is based on the spring constant of springs 116. In some embodiments, wheels are provided near the top of the elevator car 22 that are idler wheels that follow along the vertical structure 30 without providing torque to move the elevator car 22.

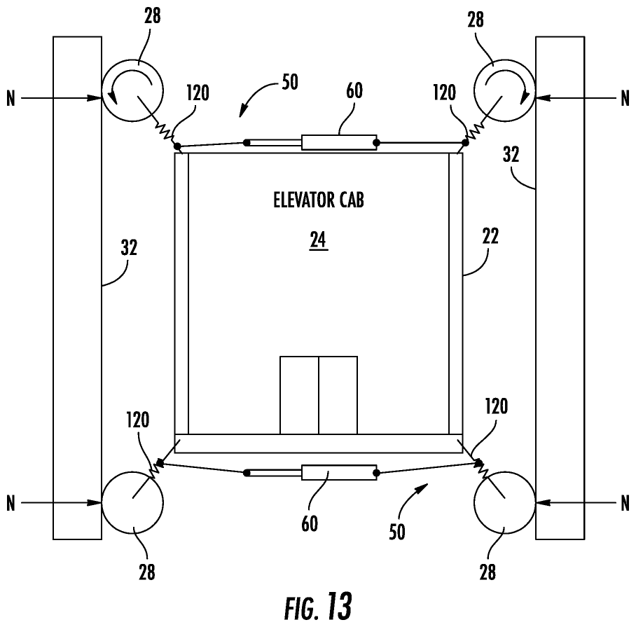

FIG. 13 shows another configuration of a biasing mechanism 50. This example embodiment includes flexible mounts 120 that support the drive members 28. The mounts 120 may be springs or include springs with additional structural members. The flexible mounts 120 provide some resiliency while always maintaining at least a minimum required biasing force urging the drive members 28 into engagement with the surfaces 32. The actuators 60 in FIG. 13, which may be electric, electromagnetic, electromechanical, hydraulic or pneumatic, alter the biasing force by imposing a force on the spring-based mounts 120.

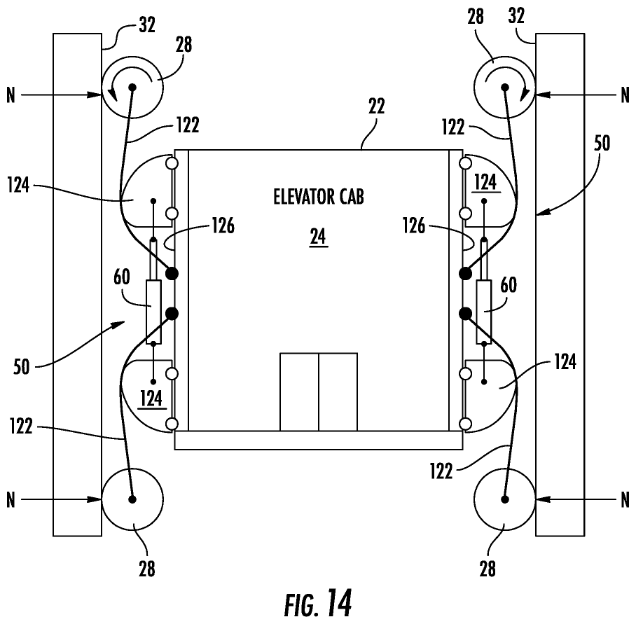

The biasing mechanism 50 in FIG. 14 includes flexible mounts 122. In some such embodiments, the mounts 122 comprise springs. The actuators 60 in the illustrated example are connected with deflectors 124 that move along a track 126 on the elevator car 22. The actuators 60 cause movement of the deflectors to alter the biasing force imposed by the resilient mounts 122. As in previously discussed embodiments, the actuators may be electric, electromagnetic, electromechanical, hydraulic or pneumatic.

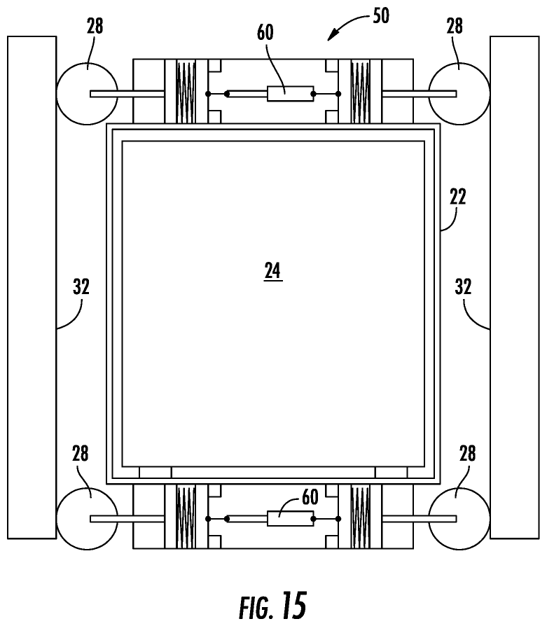

In FIG. 15, actuators 60 are arranged to expand or contract to change the biasing force urging the drive members 28 into engagement with the surfaces 32 as the load of the elevator car 22 changes. The drive members 28 near the top of the elevator car 22 in this example may be urged with a different biasing force than that applied to the drive members 28 near the bottom of the elevator car 22. Additionally, either of the actuators 60 in such an embodiment may be used to apply a biasing force that is strong enough to serve as a safety braking force while at least the corresponding drive members 28 are prevented from rotating.

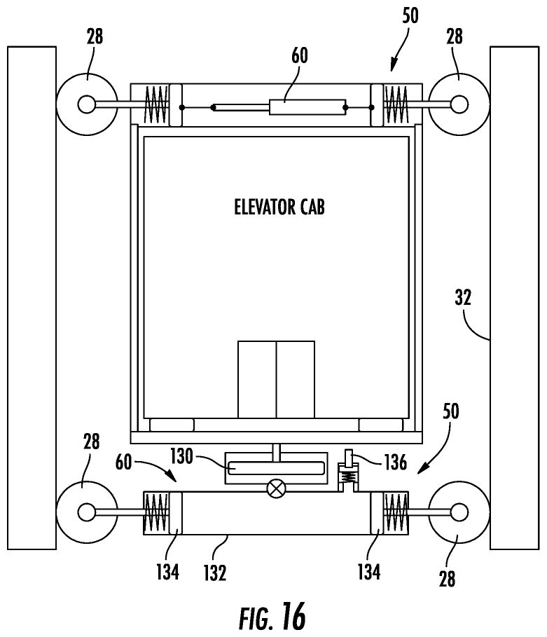

The arrangement shown in FIG. 16 includes an actuator 60 near the top of the elevator car 22 like those shown in FIG. 15. This embodiment also includes a passive, hydraulic biasing mechanism 50 near the bottom of the elevator car 22. As the load of the elevator car 22 changes, a plunger 130 moves vertically to change the amount of hydraulic fluid in a chamber 132. The hydraulic fluid acts against pistons 134 that move in a direction to change the biasing force on the drive members 28.

The example embodiment of FIG. 16 includes a back-up actuator 136 that can be controlled independently of the plunger 130 to alter the pressure within the chamber 132 if needed to achieve a desired biasing force. The actuator 60 near the top of the elevator car 22 in this example may be used to apply a biasing force to achieve traction for moving the elevator car 22 or may be used exclusively to apply a biasing force that is sufficient to use the associated drive members as brake members for a safety brake application.

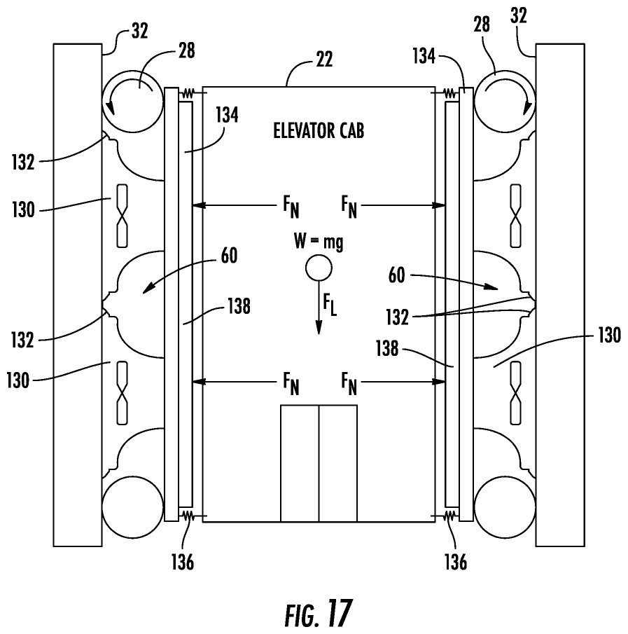

FIG. 17 includes pneumatic actuators 60 that utilize air pressure. In this example, vacuum portions 130 each include a seal 132 received against the surface 32. The seals 132 are flexible and able to slide along the surface 32 while maintaining a sufficient seal for the vacuum portions 130 to establish a vacuum. The vacuum effect draws a base 134 toward the surface 132 and, therefore, urges the drive members 28, which are supported by the base 134, toward the surface to achieve a desired biasing force. The bases 134 are resiliently supported on the elevator car 22 as shown at 136 so the base 134 can be moved relative to the surfaces 32 based on changes in the vacuum pressure of the vacuum portions 130.

The example shown in FIG. 17 also includes a compressed air chamber 138 associated with each side of the elevator car 22. In some implementations, the compressed air chamber 138 is used to release a portion of the vacuum of the vacuum portions 130 for lessening the biasing force by introducing additional air into the vacuum portions 130 in response to a decrease in the load of the elevator car 22.

Although not illustrated in FIGS. 10-17, the controller 25 controls the actuators 60 to alter the biasing force based on a change in the load of the elevator car 22.

The illustrated example embodiments include various features that can be advantageous. For example, in a cantilevered arrangement, situating the drive mechanism 26 on only one side of the elevator car 22 leaves more room in the hoistway 38 to accommodate a larger sized elevator cab 24 or a variety of car configurations. Additionally, it is possible to position a door 200 (FIG. 2) of the elevator car on any of the three remaining sides of the elevator cab 24 other than the one that the drive mechanism 26 is situated near. In addition to utilizing hoistway space more efficiently, less material is required with a drive mechanism near only one side of the elevator car frame. Reducing the required amount of materials reduces the costs of an elevator system.

Other features of example embodiments include reduced installation time, which is due for example to the requirement for only one structural member on only one side of the elevator car. Additionally, the structural member may be more strategically placed where load rated attachment points are more easily or more effectively accommodated inside the hoistway.

Another feature of the illustrated example embodiments is the ability to change the biasing force based on the condition or state of the elevator car. Changing the biasing force responsive to the load of the elevator car 22 allows for avoiding unnecessary wear on the drive members 28 and the surfaces 32 while consistently providing a sufficient biasing force under different conditions, such as those mentioned above.

Another feature of example embodiments is that it becomes more straightforward to incorporate more than one elevator car in a single hoistway. Multiple cars can use the same structural member without complicated arrangements to avoid interference between the operative components of the drive mechanisms for each car. Some embodiments include the ability to transfer elevator cars among different hoistways. The United States Patent Application Publications US 2109/0077636 and US 2109/0077637 each show ways of transferring elevator cars among hoistways and having more than one car in a hoistway. The teachings of those two published applications are incorporated by reference into this description.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator, comprising:
an elevator car;
a drive mechanism connected with the elevator car, the drive mechanism moving with the elevator car in a vertical direction, the drive mechanism including at least one drive member that is configured to
engage a vertical structure near the elevator car,
climb along the vertical structure to selectively cause movement of the elevator car, and
selectively prevent movement of the elevator car when the at least one drive member remains in a selected position relative to the vertical structure; and
a biasing mechanism that urges the at least one drive member in a direction to engage the vertical structure, the biasing mechanism applying a biasing force based upon a condition of the elevator car, the biasing force changing based upon a change in the condition.

2. The elevator of claim 1, wherein
the vertical structure includes a traction surface that the at least one drive member engages,
the at least one drive member rotates while engaging the traction surface, and
the biasing force is normal to the traction surface.

3. The elevator of claim 1, wherein
the biasing mechanism comprises an actuator that applies the biasing force, and
the actuator varies the biasing force based on the change in the condition.

4. The elevator of claim 3, wherein the condition comprises a load of the elevator car, and comprising a sensor that provides an output indicating the load of the elevator car, and
a controller that determines the load in the elevator car based on the output of the sensor, and
wherein the actuator is controlled by the controller to change the biasing force for urging the at least one rotatable drive member to engage the vertical structure based on the change in the load in the elevator car.

5. The elevator of claim 4, wherein the actuator
increases the biasing force for urging the at least one rotatable drive member in a direction to engage the vertical surface based on an increase in the load of the elevator car, and
decreases the biasing force for urging the at least one rotatable drive member in the direction to engage the vertical surface based on a decrease in the load in the elevator car.

6. The elevator of claim 4, comprising a feedback sensor that provides an indication of the biasing force between the at least one rotatable drive member and the vertical structure, and wherein the controller uses the indication from the feedback sensor to selectively adjust the biasing force applied by the actuator.

7. The elevator of claim 1, wherein
the at least one drive member comprises a plurality of rotatable drive members,
the biasing mechanism comprises a plurality of beams supported for movement in a first direction to urge the at least one rotatable drive member into engagement with the vertical structure,
the at beams move at least partially in a first direction based upon a force in a second, different direction, and
the load of the elevator car is in the second direction.

8. The elevator of claim 7, wherein the plurality of beams that are supported for pivotal movement relative to each other to change the biasing force.

9. The elevator of claim 8, wherein
the biasing mechanism includes an actuator that causes movement of the beams based on a change in the load of the elevator car, and
the actuator is one of electrical, electromagnetic, hydraulic or pneumatic.

10. The elevator of claim 1, wherein
the at least one drive member comprises a plurality of rotatable drive members,
the drive members are supported by flexible mounts, and
the biasing mechanism includes at least one actuator that changes a condition of the flexible mounts to change the biasing force.

11. The elevator of claim 10, wherein the actuator imposes a force on the flexible mounts to change the condition.

12. The elevator of claim 10, wherein the actuator causes deflection of the flexible mounts to change the biasing force.

13. The elevator of claim 12, wherein the biasing mechanism includes deflectors that are moveable by the actuator to deflect the flexible mounts in a manner that changes the biasing force.

14. The elevator of claim 1, wherein
the biasing mechanism includes a chamber configured to contain a fluid,
the biasing force is based on an amount of fluid in the chamber or a pressure of the fluid in the chamber,
the biasing mechanism includes a plunger that is moveable relative to the chamber based on a change in the load of the elevator car, and
movement of the plunger changes the biasing force.

15. The elevator of claim 1, wherein the biasing mechanism includes a vacuum chamber that establishes an at least partial vacuum to apply the biasing force.

16. The elevator of claim 15, wherein
the vacuum chamber includes a flexible seal that is received against a surface of the vertical structure,
the flexible seal is moveable in a vertical direction along the surface as the elevator car moves, and
vacuum pressure of the vacuum chamber urges the at least one rotatable drive member into engagement with the vertical structure.

17. A method of controlling movement of an elevator car, the method comprising:
connecting a drive mechanism with the elevator car, the drive mechanism including at least one drive member that is configured to engage a vertical structure near the elevator car;
moving the drive mechanism with the elevator car in a vertical direction by causing the at least one drive member to climb along the vertical structure;
preventing movement of the elevator car by maintaining the at least one drive member in a selected position relative to the vertical structure;
urging the at least one drive member in a direction to engage the vertical structure using a biasing mechanism for applying a biasing force based upon a condition of the elevator car; and
changing the biasing force based upon a change in the condition.

18. The method of claim 17, wherein the condition comprises at least one of a load of the elevator car and an status of the elevator car.

19. The method of claim 16, wherein the status includes an active status in which the elevator car is providing elevator service or an inactive status in which the elevator car is parked in a designated position.

20. The method of claim 19, comprising releasing the biasing force when the inactive status includes the elevator car parked in the designated position and vertically supported independent of the at least one drive member engaging the vertical structure.
